(19) United States
(12) Patent Application Publication
(10) Pub. No.: US 2013/0104220 A1
(43) Pub. Date: Apr. 25, 2013

(54) System and method for implementing a secure USB application device

(71) Applicant: Kwang Wee Lee, Singapore (SG)

(72) Inventor: Kwang Wee Lee, Singapore (SG)

(21) Appl. No.: 13/373,955

(22) Filed: Dec. 6, 2011

Related U.S. Application Data
(60) Provisional application No. 61/628,092, filed on Oct. 24, 2011.

(51) Int. Cl. H04L 29/06

(52) U.S. Cl. 726/9

(57) ABSTRACT

Systems and methods for implementing a secure USB token are described. In one aspect, the system for implementing a secure USB token, the system comprising: (1) a secure USB token including: a processor; a memory coupled to said processor; a communication port coupled to said processor, a secure element coupled to said processor, said secure element storing data for implementing a secure environment; one or more applications stored on said memory adapted to run on said memory and processor; and (2) a host device including: a processor; a memory coupled to said processor; a communication port coupled to said processor; and an agent displayed on the host device; wherein the agent launches one or more of the applications stored on the USB token, and wherein the agent prevents the host device from accessing the USB token's memory.

### CROSS-REFERENCE TO RELATED APPLICATIONS

This application claims priority to U.S. Provisional Patent Application No. 61/628,092, filed Oct. 24, 2011 having the same title and naming the same inventor, the disclosures of which are incorporated herein by reference.

### FIELD OF THE INVENTION

The present invention relates to systems and methods for implementing a secure USB device.

### BACKGROUND OF THE INVENTION

Current online internet-based banking and payment systems on PC are prone to attacks from viruses and malware that have become more intelligent. To improve security and protect a user's log-in credentials, bank and payment sites implement multifactor authentication using a one time password token and SMS password from a user's phone or mobile device. However, some viruses are no longer interested in this password. Instead, the virus allows the user to log in to the interne banking/payment site normally, allowing all the multifactor authentication entries from the user and the establishment of secure link like secure software layer (“SSL”). The virus can either put a hook in the operating system (“OS”) or modify the PC browser so that the virus can see what URL and parameters are submitted to the banking/payment site before the secure software layer.

One example of the attack by the virus can occur when the user is making a transfer from the user's bank account to another. The virus will detect that a transfer is going to be placed into account xxxx in an amount of $yyy. When the user hits the submit key, instead of the browser submitting the user's parameters through the secure channel out to the bank, the virus intercepts these parameters and modifies the transfer account and amount to another party which the user did not intend. Then the virus sends the altered parameters via the secure channel on the PC to the bank site. The virus can now redirect funds from the user's intended account to some other account and amount.

In order to prevent man-in-the-middle attacks, phishing attempts, man-in-the-browser attacks and the like, some companies developed hardened browsers that prevent modification of the browser code from attack by using a CD-ROM version of the browser that can be run from the CD-ROM without installation on the PC. An example of this product is the Vasco hardened browser CD-ROM base thumb drive. The disadvantage of Vasco's hardened browser is that the browser is still running with the host PC's resources (e.g., memory) that are also vulnerable to attack. The current invention is a Secure USB Token (“SUT”) that does not expose its software codes or run-time data memory to the host PC. A virus on the host PC will not be able to modify any of the data of the Application on the SUT.

### SUMMARY OF THE INVENTION

This disclosure describes systems and methods for implementing a secure USB token for use with a host device, that will permit applications to run on the USB token's processor and memory securely, regardless if the host device is compromised with viruses or other malware. An agent on the host device launches applications located on the USB token, and prevents the host from accessing the USB token's file system.

Embodiments of this invention include a system and method where the application running on the USB device sends graphic commands to the host device, and the rendering is handled by the host device. Furthermore, the invention does not expose the file system of the USB to applications or viruses that may be on the host PC. Embodiments of the invention use an agent to launch an application on the USB device and only applications that the management channel allows on the USB device can be launched.

The present invention is different from that described in U.S. patent application Ser. No. 12/660,723, owned by Cassis International. In the Cassis application, the system is simply a virtual network computer (“VNC”) setup. A VNC does all the graphic rendering on the USB device and the whole screen buffer is transferred to the host system. This requires a high volume of display frame buffer memory transfer from the USB device to the host device to display. The Cassis design therefore needs a high processing power on the USB device to render graphics, and the graphics display capabilities are limited due to the high volume of data required to transfer the screen buffer.

The present invention's design requires less processing power from the USB device and less graphic traffic communication between the USB and host devices, and makes full use of the power of the host device to render/process the graphics display. In the VNC setup, the whole desktop display of the OS running on the USB device is sent to the host device. This exposes the file system of the USB's OS and malicious applications can be downloaded to and launched from the exposed file system.

### BRIEF DESCRIPTION OF THE DRAWINGS

Features and other aspects of the embodiments of the present invention are explained in the following description taken in conjunction with the accompanying drawings, wherein:

FIG. 1 illustrates a block diagram showing a hardware stack for a SUT according to an embodiment of the invention;

FIG. 2 illustrates a block diagram showing the software stack for a SUT according to an embodiment of the invention.

FIG. 3 illustrates the start sequence of an application on the SUT by an agent on the host according to an embodiment of the invention.

### DETAILED DESCRIPTION

Various embodiments of the invention will now be described in greater detail with reference to the drawings.

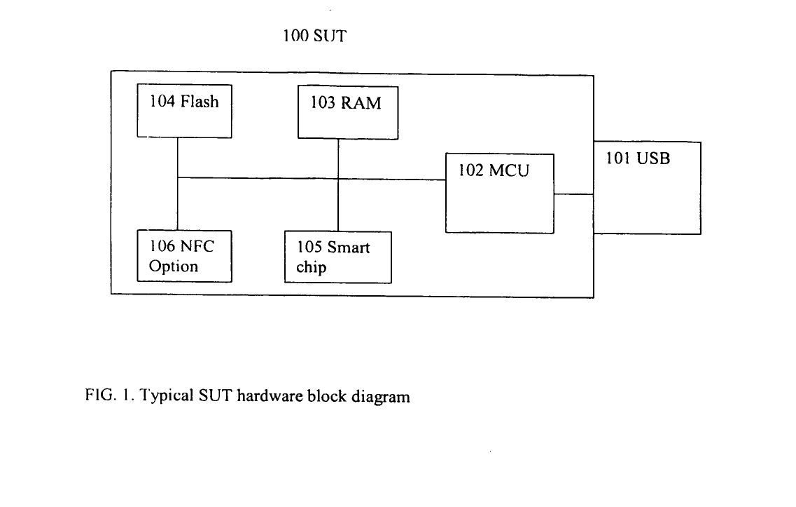

FIG. 1 shows the hardware stack of an embodiment of a SUT 100. The SUT 100 consists of a device that may interface with a host via a USB port 101, and contains a processor 102, RAM 103, flash memory 104 and secure element 105 but is not only limited to these components.

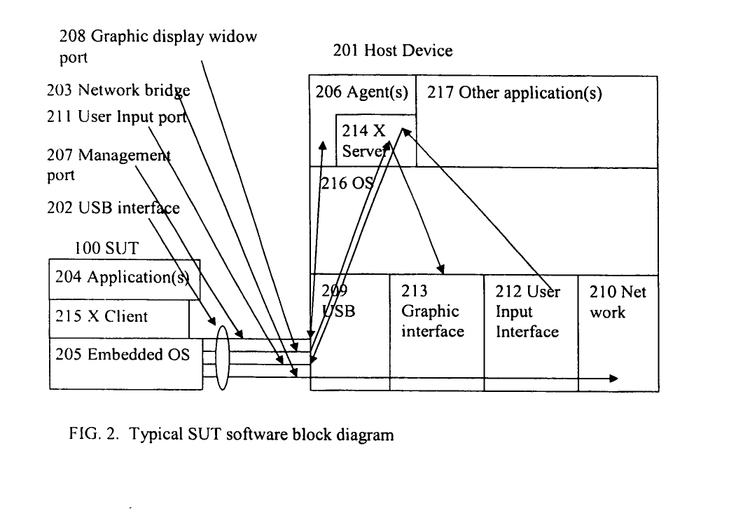

FIG. 2 shows the software stack of an embodiment of a SUT 100. This SUT device can be connected via USB 202 to any host 201 system that has network access 210, a display 213 and a user input interface device 212 (e.g., keyboard, mouse, touch pad, remote control). Examples of a host 201 device include a personal computer or an internet enabled television. A SUT application 204 or applications run on an embedded OS 205 on the SUT's hardware. The SUT application(s) 204 are triggered to run by their individual agent 206 on the host device 201. An agent 206 is an application that runs on the host device 201 that the SUT 100 connects to.

The agent 206 launches the application 204 on the SUT using the management port 207. The application 204 on the SUT sends the application graphic rendering to the agent 206 on host device periodically through the graphic display port 208. The SUT will not need graphic rendering capability as the drawing command is directly sent to the agent 206 on the host device 201 for rendering. Rendering graphics remotely makes full use of the host device's 201 graphic hardware, speeds up the rendering process, and reduces the SUT's processor (MCU) 102 requirements, thus making it more efficient. User input on the host device is communicated through the agent 206 to the application 204 on the SUT. The SUT can get network 210 access through the network bridge 203 on the host device through the USB port 209. The host's OS 216 provides the environment for the agent to run on. The host's OS 216 can be Microsoft Windows, Mac OS, Linux or any other that can support graphics display, rendering capability, and user input. The agent opens a window in the host OS desktop screen and renders the SUT application's 204 display in it. The host OS 216 can support applications 217 that are native to the host while the agent is running.

In a preferred embodiment, there will be no support for desktop window display for the SUT OS 205 on the host device 201. Not supporting the desktop display on the host protects the SUT file system from any outside access. The SUT file system is further protected by the agent 206, which only allows launching applications 204 that are built into the SUT. This lack of interface with the SUT file system makes it harder to put foreign applications (e.g., viruses) into the SUT and launch them.

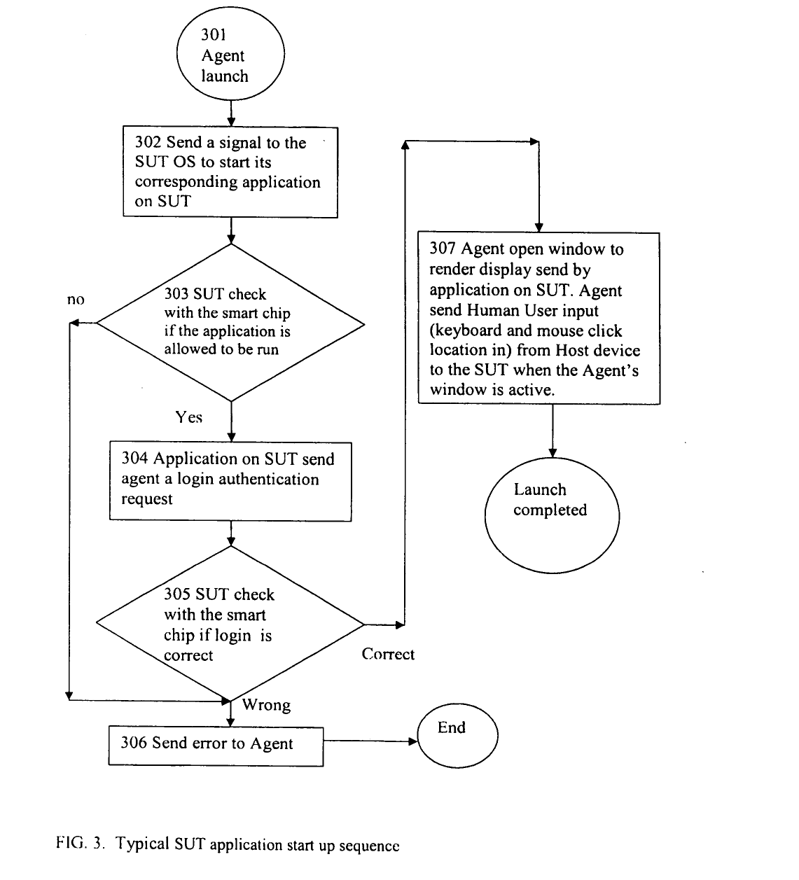

FIG. 3 shows the start sequence of an application on the SUT by an agent on the host according to an embodiment of the invention. According to this embodiment, when the agent is launched 301, it sends a signal to the SUT OS to start the corresponding application on the SUT 302. The SUT uses the smart chip to check if the specific application can be run on the SUT 303. If the application is not permitted to run on the SUT, an error message is sent to the agent 306. If the application is approved, the application can send a request for login authentication to the agent 304. The smart chip checks the login credentials 305. If the login credentials are incorrect, an error message is sent to the agent 306. If the login credentials are correct, the agent opens a window on the host device to render the display sent by the SUT 307. The agent also sends user input (e.g., mouse, keyboard, etc.) from the host device to the SUT when the agent window is active 307.

Description of the Sub System

The SUT itself does not have graphic display hardware. Applications 204 on the SUT update the host's graphic display using the display channel directly to the host device's agent 206. The display channel can be implemented using OpenGL, XGL, CGL, WGL or similar protocol. The agent 206 on the host device side receives the graphic display command through the graphics display port 208 over the USB. The agent 206 will open a graphic display window on the host device display and draw the graphic on it. The graphics display data may be encrypted to enhance the security against parties who are not the intended recipients of the graphic data. The encryption can be made over the management channel prior to the start of the SUT application. The application 204 on the SUT is launched by the agent 206 in the host system via the management port 207.

The management port 207 is a management channel that allows the agent 206 on the host device to communicate to the SUT to start or terminate the application 204. Only registered SUT applications 204 on the SUT can be launched through the agent 206 to prevent placing and launching an unauthorized application on the SUT.

The graphics display port 208 provides a channel for the application 204 on the SUT to communicate the display channel command to the agent 206 on the host device.

The user input port 211 provides a channel for the SUT to receive the user inputs from the agent 206 on the host device when the application is active. In one embodiment, data can be entered securely via a keypad rendered by the SUT on the host device's graphics display. The agent 206 will send only the mouse click or other user input device's position of the on-screen key location and not what key is being selected. Decoding what key corresponds to the on-screen location will be done on SUT side.

The network bridge 203 allows the SUT to access the internet using the host device's network resources 210. The SUT may create a secure channel with the outside world by encrypting data on the SUT before it leaves the SUT. SSL or another form of encryption can enhance security against sniffing or phishing by viruses on the host device.

In a preferred embodiment, the SUT hardware will appear as a composite USB device to the host OS 216: it will appear as a USB CDC Ethernet class device and a CD-ROM read-only device. The CDC Ethernet class device provides all the communicating channel for the agents to the SUT. The CD-ROM (read only) portion contains the agent 206 programs to be run on the host 201. The agent program can be run directly from this mounted CD-ROM. Having the agent 206 in a read-only CD-ROM format does not require installing the agent on the host device 201 and thus provides security for the agent code. The agent will communicate with the SUT OS 205 to launch its corresponding application 204 on the SUT. The agent can establish a secure channel for the graphic display port 208 and user input port 211. The agent can open a window and render the graphic command from the application 204 in the SUT to the window. Every application 204 running on the SUT will require a different agent 206 to launch and render a new display window associated with that application. In one embodiment, every application opens a new window or in the case of a web browser running on the SUT, when the user clicks a new browser window in the browser already running in the SUT, a new window will open in the host device. An agent can launch more than one type or application using selection of application at start up or individual agent for different type of application.

The smart chip (or secure element) 105 provides the encryption engine and passwords/data storage for the SUT. The smart chip 105 can be any physical and electrical tamper-proof device for storing and executing encryption algorithms and passwords/data. As an example, the smart chip 105 may be used as a secure storage area for the list of executable files that can be executed on the SUT so as to prevent virus or backdoor access program from executing on the SUT. The SUT OS can verify that a program is on the list on the smart chip 105 prior to executing it. As another example, the agent 206 on the host may require a user to log in with a password. The smart chip 105 can be used to verify the password prior to executing the SUT application 204 requested by the agent 206. The smart chip 105 can also provide password authentication to applications running on the SUT (e.g., log in password for email applications, internet website ID/Password and authentication for banking or payment websites, and other applications requiring password authentication).

In another embodiment, a near field communication (“NFC”) reader/writer chip 106 can be implemented to the SUT. The NFC chip 106 can allow a SUT application 204 to perform banking transactions using, for example, EMV bank cards. An EMV card placed on the SUT can communicate with the application 204 running on the SUT via the NFC chip 106. When an application 204 is performing a banking transaction (e.g., payment, fund transfer, etc.) the host server (e.g., internet banking/secure payment server) can check the authenticity of the card by sending authentication challenges to the EMV card via the NFC chip 106.

Detailed Implementation of the System

In a preferred embodiment, the processor, ARM cortex A8 mobile application processor was used to build the SUT with flash and RAM. The design is not limited to only this MCU. In another embodiment, Linux was used as the SUT OS.

As an example, the X Windows client is implemented on the Linux OS for applications 204 running on the SUT to channel the graphic display for the application to the agent 206 via the USB connection 209 to a host PC running an agent that has X Server 214 capability. The X Client 215 can run on the SUT because it does not render the application graphic user interface and thus reduces the work load of the SUT processor. This can reduce the cost of implementation because it allows the SUT processor to not have graphic accelerator hardware. The applications 204 running on the SUT send the graphical user interface (“GUI”) command to the X Client 215, which sends it to the agent 206 on the host PC via the USB channel. The agent implements X Server 214 capability and does the graphic rendering on the host PC. The SUT can therefore take advantage of the host PC's existing graphic display capabilities to perform heavy graphic rendering. The application 204 will be able to map its display window size to that of the window open by the agent 206 on the host device 201. The window on the host device can be resized and the agent can communicate the new size to the X Client that can resize it to match the host display.

The agent can run on a PC host where the PC can be any personal computer running Microsoft OS, MAC OS, any PC, tablet or smart phone with display, user input and USB host capabilities.

In a preferred embodiment, when the agent's window is active on the host PC, all the user's input (e.g., keyboard, mouse) will be channeled by the agent's X Server 214 to the X Client 215 and then to the application running on the SUT. All the communication between the SUT and the agent on the host can be encrypted to prevent packet sniffing.

Examples of SUT Applications

SUT is best suited for applications such as web browsers, email, or other applications that are often targeted by viruses, keyloggers, spyware and the like. The applications run on the SUT's processor/memory and not on the host PC. Applications on the SUT do not leave traces on the PC as all data that enters or leaves the SUT is encrypted. The SUT's applications codes are secure and cannot be modified because the host does not have access to the SUT's file system. In a further embodiment, the agent X Server 214 can make it harder for a keystroke virus to do screen capture by directly rendering on the graphic card and not rendering on the host frame buffer.

Although various aspects of the present invention have been described in several embodiments, a myriad of changes, variations, alterations, transformations, modifications may be suggested to one skilled in the art, and it is intended that the present invention encompass such changes, variations, alterations, transformations, and modifications as fall within the spirit and scope of the appended claims.

1. A system for implementing a secure token, the system comprising:
a secure token including:
a first processor;
a first memory coupled to said first processor;
a first communication port coupled to said first processor;
a secure element coupled to said first processor for implementing a secure environment;
one or more applications stored on said first memory adapted to run on said first memory and said first processor; and
a host device including:
a second processor;
a second memory coupled to said second processor;
a second communication port coupled to said second processor and said first communication port;
an agent displayed on said host device;
wherein the agent launches one or more of said applications stored in the first memory on the secure token, and wherein the agent prevents said host device from accessing said first memory.

2. The system of claim 1, wherein the secure token adheres to a USB dongle form factor.

3. The system of claim 1, wherein the secure token sends graphic commands to the host device using one or more of OpenGL, XGL, CGL, WGL, or other protocol.

4. The system of claim 1, wherein the secure token is adapted to display data on one or more of a personal computer, tablet, television, digital photo frame, or smart phone.

5. The system of claim 1, wherein the communication port is one or more of a USB, firewire, near field communication, or network connection to the host device.

6. The system of claim 1, wherein the secure token comprises a near field communication element.

7. The system of claim 1, wherein data stored on the secure element includes keys, passwords, list of approved executable files, or a data encryption algorithm.

8. The system of claim 1, wherein the secure token communicates with the host device using one or more of VPN, SSL, or other encryption.

9. The system of claim 1, wherein the agent is stored on the secure token.

10. The system of claim 1, wherein the agent is run from the secure token.

11. The system of claim 1, wherein the host device is one or more of a personal computer, tablet, television, digital photo frame, or smart phone.

12. The system of claim 1, wherein the host device includes an input device consisting of one or more of a keyboard, joystick, mouse, keypad, touch screen, push button, trackball, remote control or microphone.

13. A secure token for communicating with a host device, the secure token comprising:
a processor;
a memory coupled to said processor;
a communication port coupled to said processor and said host;
a secure element coupled to said processor for implementing a secure environment; and
one or more applications stored on said memory adapted to run on said memory and processor;
wherein an agent launches one or more of said applications stored on the token, and wherein the agent prevents said host device from accessing the token memory.

14. The secure token of claim 13, wherein the secure token adheres to a USB dongle form factor.

15. The secure token of claim 13, wherein the secure token sends graphic commands to the host device using one or more of OpenGL, XGL, CGL, WGL, or other protocol.

16. The secure token of claim 13, wherein the secure token is adapted to display data on one or more of a personal computer, tablet, television, digital photo frame, or smart phone.

17. The secure token of claim 13, wherein the communication port is one or more of a USB, firewire, near field communication, or network connection to the host device.

18. The secure token of claim 13, wherein the secure token comprises a near field communication element.

19. The secure token of claim 13, wherein data stored on the secure element includes keys, passwords, list of approved executable files, or a data encryption algorithm.

20. The secure token of claim 13, wherein the secure token communicates with the host device using one or more of VPN, SSL, or other encryption.

21. The secure token of claim 13, wherein the agent is stored on the secure token.

22. The secure token of claim 13, wherein the agent is run from the secure token.

23. A host device for implementing a secure token having applications stored in a memory, the system comprising a host device that includes:
a processor;
a memory coupled to said processor;
a communication port coupled to said processor and said token; and
an agent displayed on said host device;
wherein the agent launches one or more of said applications stored in the token memory, and wherein the agent prevents said host device from accessing the token memory.

24. The host device of claim 23, wherein the host device is one or more of a personal computer, tablet, television, digital photo frame, or smart phone.

25. The host device of claim 23, wherein the host device communicates with the secure token using one or more of a USB, firewire, near field communication, or network connection.

26. The host device of claim 23, wherein the host device communicates with the secure token using one or more of VPN, SSL, or other encryption.

27. The host device of claim 23, wherein the host device includes an input device consisting of one or more of a keyboard, joystick, mouse, keypad, touch screen, push button, trackball, remote control or microphone.

28. A method for implementing a secure token in communication with a host device, the method comprising:
storing one or more applications on the token's memory;
communicating instructions for displaying one or more agents on a host device;
receiving, from said host device, instructions for launching one or more applications on said token; and
receiving instructions preventing said host device from accessing said token memory.

29. The method of claim 28, wherein the secure token adheres to a USB dongle form factor.

30. The method of claim 28, wherein the secure token sends graphic commands to the host device using one or more of OpenGL, XGL, CGL, WGL, or other protocol.

31. The method of claim 28, wherein the secure token is adapted to display data on one or more of a personal computer, tablet, television, digital photo frame, or smart phone.

32. The method of claim 28, wherein the host device is one or more of a personal computer, tablet, television, digital photo frame, or smart phone.

33. The method of claim 28, wherein the token comprises a secure element for implementing a secure environment.

34. The method of claim 33, wherein data stored on the secure element includes keys, passwords, list of approved executable files, or a data encryption algorithm.

35. The method of claim 28, wherein the secure token communicates with the host device using one or more of VPN, SSL, or other encryption.

36. The method of claim 28, wherein the agent is stored on the secure token.

37. The method of claim 28, wherein the agent is run from the secure token.

38. The method of claim 28, wherein the secure token communicates via one or more of a USB, firewire, near field communication, or network connection to the host device.

39. The method of claim 28, wherein the secure token comprises a near field communication element.

40. The method of claim 28, wherein the host device includes an input device consisting of one or more of a keyboard, joystick, mouse, keypad, touch screen, push button, trackball, remote control or microphone.

41. A system for implementing a secure token, the system comprising:
a secure token including:
means for running one or more applications;
means for communicating with a host device;
means for implementing a secure environment; and
a host device including:
means for running applications;
means for communicating with a secure token;
means for displaying an agent that can launch one or more of the applications stored on the token; and
means for preventing the host device from accessing the token's memory.
